(19) United States
(12) Patent Application Publication
(10) Pub. No.: US 2024/0184626 A1
(43) Pub. Date: Jun. 6, 2024

(54) PROCESSING SYSTEM, PROCESSING METHOD, AND PROCESSING PROGRAM

(71) Applicant: DENSO CORPORATION, Kariya-city, Aichi-pref. (JP)

(72) Inventor: AKIRA MIKI, Kariya-city (JP)

(21) Appl. No.: 18/520,404

(22) Filed: Nov. 27, 2023

(30) Foreign Application Priority Data
Nov. 29, 2022 (JP) 2022-190585

(51) Int. Cl. G06F 9/48; G06F 17/18

(52) U.S. Cl. CPC G06F 9/4881; G06F 17/18

(57) ABSTRACT

A processing system includes a parallel processing processor in which threads is constructed for each of blocks, and that optimizes a combination of binary variables under a one-hot constraint. A group variable is defined with a combination pattern satisfying the one-hot constraint as a solution candidate for each of groups of the binary variables. The parallel processing processor executes assigning the solution candidate of the group variable for each of the threads in each of the blocks, searching for an output value of the group variable in each of the blocks, and outputting the output value of all the group variables having been searched.

### CROSS REFERENCE TO RELATED APPLICATION

The present application claims the benefit of priority from Japanese Patent Application No. 2022-190585 filed on Nov. 29, 2022. The entire disclosures of all of the above application are incorporated herein by reference.

### TECHNICAL FIELD

The present disclosure relates to a processing technique of optimizing a combination of binary variables.

### BACKGROUND

A related art discloses a processing technique of optimizing a combination of binary variables under a one-hot constraint. In the processing technique disclosed in the related art, a combination optimization problem satisfying the one-hot constraint is divided into a plurality of partial problems to improve solving performance.

### SUMMARY

According to one example, a processing system may include a parallel processing processor in which threads is constructed for each of blocks, and that optimizes a combination of binary variables under a one-hot constraint. A group variable is defined with a combination pattern satisfying the one-hot constraint as a solution candidate for each of groups of the binary variables. The parallel processing processor executes assigning the solution candidate of the group variable for each of the threads in each of the blocks, searching for an output value of the group variable in each of the blocks, and outputting the output value of all the group variables having been searched.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing an overall configuration of a processing system according to a first embodiment;

FIG. 2 is a block diagram showing a detailed configuration of a parallel processing processor according to the first embodiment;

FIG. 3 is a block diagram showing a functional configuration of the processing system according to the first embodiment;

FIG. 4 is a flowchart showing a processing flow according to the first embodiment;

FIG. 5 is a flowchart showing a processing flow according to the first embodiment;

FIG. 6 is a schematic diagram for describing the processing flow according to the first embodiment;

FIG. 7 is a schematic diagram for describing the processing flow according to the first embodiment;

FIG. 8 is a schematic diagram for describing the processing flow according to the first embodiment;

FIG. 9 is a schematic diagram for describing the processing flow according to the first embodiment;

FIG. 10 is a schematic diagram for describing the processing flow according to the first embodiment;

FIG. 11 is a flowchart showing a processing flow according to a second embodiment;

FIG. 12 is a flowchart showing a processing flow according to a third embodiment;

FIG. 13 is a flowchart showing a processing flow according to the third embodiment;

FIG. 14 is a flowchart showing a processing flow according to the third embodiment;

FIG. 15 is a schematic diagram for describing the processing flow according to the third embodiment; and

FIG. 16 is a schematic diagram for describing the processing flow according to the third embodiment.

### DETAILED DESCRIPTION

In the processing technique of a relate art in which the optimization problem is divided into the plurality of partial problems, although an increase in speed of solving processing by the division can be achieved as the solving performance, solving accuracy is limited by the division.

The present disclosure provides a processing system that achieves both an increase in speed of solving processing and an improvement in solving accuracy. The present disclosure provides a processing method of achieving both an increase in speed of the solving processing and an improvement in the solving accuracy. The present disclosure provides a processing program that achieves both an increase in speed of the solving processing and an improvement in the solving accuracy.

According to one aspect of the present disclosure, a processing system may include a parallel processing processor in which a plurality of threads is constructed for each of a plurality of blocks, and that is configured to optimize a combination of binary variables under a one-hot constraint. A group variable is defined with a combination pattern satisfying the one-hot constraint as a solution candidate for each of groups of the binary variables. The parallel processing processor is configured to execute assigning the solution candidate of the group variable for each of the threads in each of the blocks, searching for an output value of the group variable on a basis of an energy evaluation value for the solution candidate of the group variable assigned for each of the threads in each of the blocks, and outputting the output value of all the group variables having been searched.

According to another aspect of the present disclosure, a processing method of optimizing a combination of binary variables under a one-hot constraint by a parallel processing processor in which a plurality of threads is constructed for each of a plurality of blocks is provided. A group variable is defined with a combination pattern satisfying the one-hot constraint as a solution candidate for each of groups of the binary variables. The processing method may include: assigning the solution candidate of the group variable for each of the threads in each of the blocks; searching for an output value of the group variable on the basis of an energy evaluation value for the solution candidate of the group variable assigned for each of the threads in each of the blocks; and outputting the output value of all the group variables having been searched.

According to another aspect of the present disclosure, a non-transitory computer readable storage medium storing a processing program including a command that is stored in the storage medium to optimize a combination of binary variables under a one-hot constraint and is executed by a parallel processing processor in which a plurality of threads is constructed for each of a plurality of blocks is provided. A group variable is defined with a combination pattern satisfying the one-hot constraint as a solution candidate for each of groups of the binary variables. The command includes assigning the solution candidate of the group variable for each of the threads in each of the blocks, searching for an output value of the group variable on the basis of an energy evaluation value for the solution candidate of the group variable assigned for each of the threads in each of the blocks, and outputting the output value of all the group variables having been searched.

As described above, in first to third aspects in which a group variable is defined with a combination pattern satisfying a one-hot constraint for each group of a binary variable as a solution candidate, the solution candidate is assigned for each thread in each of blocks of a parallel processing processor. Therefore, in the first to third aspects, an output value of the group variable is searched for on the basis of an energy evaluation value for the solution candidate of the group variable assigned to each thread in each block of the parallel processing processor. Accordingly, the output value of the group variable is searched in parallel in each block of the parallel processing processor, and thus, the search that can ensure accuracy can be completed in a short time. Here, the output values of all the group variables output by the search are equivalent to a solution in which the combination pattern is optimized so as to satisfy the one-hot constraint for each group of the binary variable. Therefore, the first to third aspects are effective in achieving both an increase in speed of solving processing and an improvement in solving accuracy.

First, a technical background related to an embodiment of the present disclosure will be described.

In the field of quantum computation, a quantum annealer first appeared as a quantum computer, and Ising machine that classically mimic the quantum annealer by digital technology appeared as a rival. The Ising machine is a machine in which a technique related to classical simulated annealing is implemented as a dedicated chip of a digital computer for an Ising model to be solved by the quantum annealer. The leading machines are a digital annealer and a complementary metal oxide semiconductor (CMOS) annealer. Such a situation has been put on hold by an annealer of general purpose computing on graphics processing units (GPGPU) base. The GPGPU-based annealer is a technique for reproducing the performance of a dedicated computer implemented by an application specific integrated circuit (ASIC) or the like with GPGPU. This first techniques are simulated bifurcation machine (SBM) and momentum annealing (MA). All of these techniques are considered to be capable of moving with a general-purpose GPGPU machine and exhibiting performance comparable to the performance of the digital annealer and the like.

However, even in the GPGPU-based annealer, the difficulty of implementing parallelization of an algorithm of the simulated annealing with high performance has become apparent. In the case of an SBM that is said to be the fastest machine in the world faster than a quantum computer, there are many reports saying that the performance of the SBM is only good against a fully coupled Max-Cut problem that has not been exhibited in the quantum computer, and since the Max-Cut problem itself is a problem with low applicability, sufficient performance is not exhibited against a problem that an Ising machine is widely targeted. In short, one of the problems of a method of solving the Ising model by the GPGPU is that the method cannot be adapted to a general-purpose problem. On the other hand, in the case of MA in which a minor embedding method proposed by the quantum annealer is applied to a solution method of the simulated annealing, the difficulty of GPGPU acceleration is apparent. In the MA, a total coupling problem having a quadratic relationship between all variables is embedded in a bipartite graph, and half of the variables can be simultaneously updated to enable parallel calculation by the GPGPU. However, since the limit of the solving accuracy is manually introduced by minor embedding in the bipartite graph, a problem occurs in improving the solving accuracy. In short, another problem of the method of solving the Ising model by the GPGPU is that the improvement in the solving accuracy is easily limited.

In the GPGPU-based annealer, the difficulty of implementing parallelization of the algorithm of the simulated annealing with high performance is due to the difficulty of parallelization. Specifically, in the Ising problem in which all the variables are related, by performing one variable flip (one search) and performing another variable flip, information obtained by each flip cannot be mutually used. That is, since the information obtained by one variable flip is inherited only by the variable flip performed serially, information remains in the sequentially repeated histories of the searches between the independent variable flips, but the information cannot be exchanged with each other, and it is difficult to exhibit an effect of parallelization. Therefore, in the SBM, by attempting to solve the Ising model by a differential equation that is easy to parallelize, parallelization has been successful by making it possible to search the problem of a variable size Z by updating Z independent variables, but instead, versatility or usefulness is lacking. In the MA, parallelization has been successful by making it possible to search the problem of the variable size Z by Z independent variable flips. However, there is a limit to improvement of the solving accuracy instead.

Here, one attempt of parallelization is multi-start simulated annealing as the simplest parallelization method. This parallelization method is a method of performing multiple simulated annealing by using independently prepared random initial values, and finally aggregating all the simulated annealing to obtain the best result. However, the performance of the original simulated annealing is only improved by the random initial value by the amount of solution dispersion, and does not provide essential improvement as an algorithm. On the other hand, another attempt of parallelization is a replica exchange method (parallel tempering) as a representative example of a Monte Carlo calculation method developed in the context of statistical physics. This parallelization method is a method of preparing replicas for which a plurality of different temperatures is set and searching is performed in parallel, and exchanging information with precise timing between the replicas. However, introduction of an excessively parallelized replica conversely causes a decrease in performance, and the effect of parallelization is small, that is, limited even with Z parallel to the variable size Z.

In addition to the above problems, many useful optimization problems based on the Ising model always require a long one-hot constraint. However, in an Ising formulation (that is, a penalty method) in which the one-hot constraint is formulated in the Ising model, it is difficult to improve the performance. Here, in the Ising machine and a pseudo quantum technology, the performance can be improved by limiting a search technique by the one-hot constraint. On the other hand, it is known that the SBM of the GPGPU-based annealer is not suitable for implementation of the one-hot constraint. From the above background, the present disclosure provides a technology capable of achieving not only high speed by implementing efficient parallelization by GPGPU but also particularly exhibiting performance for the problem of a one-hot constraint in Ising formulation frequently used in many useful applications.

Hereinafter, a plurality of embodiments of the present disclosure will be described with reference to the drawings. Note that the same reference numerals are given to corresponding components in each embodiment, and redundant description may be omitted. When only a part of a configuration is described in each embodiment, other parts of the configuration can adopt a configuration of another embodiment previously described. Furthermore, not only a combination of configurations explicitly described in the description of each embodiment but also a partial combination of configurations of a plurality of embodiments is possible even if not explicitly described as long as the combination is not hindered.

### First Embodiment

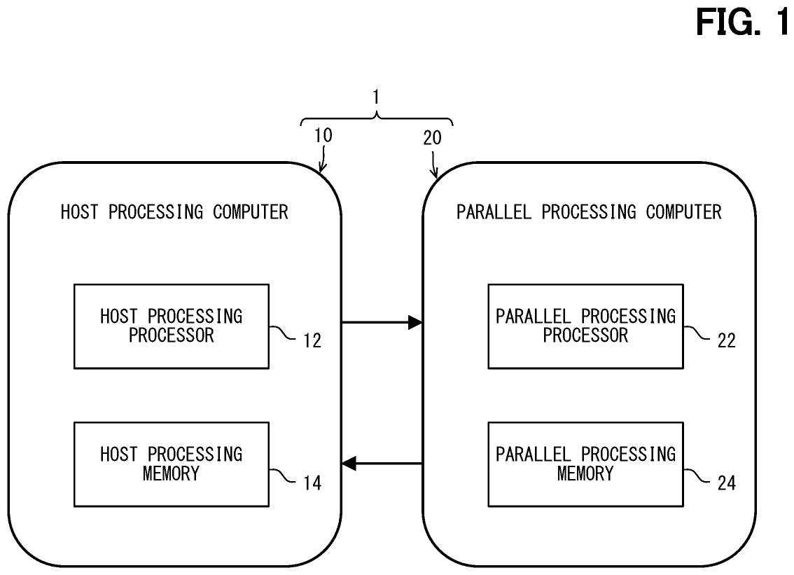

A processing system 1 according to a first embodiment shown in FIG. 1 is a computing system that executes optimization processing for solving a combinatorial optimization problem. The processing system 1 is configured by combining a host processing computer 10 and a parallel processing computer 20 as a plurality of dedicated computers. In cooperation with the processing computers 10 and 20, the processing system 1 may be used for optimization of allocation related to at least one type of mobility among demand or ridesharing taxi, distribution traveling robot, factory traveling robot, disaster countermeasure traveling robot, or the like. In cooperation of the processing computers 10 and 20, the processing system 1 may be used for at least one of optimization of a delivery route, optimization of distribution between factories, optimization of a semiconductor facility process, or the like.

The host processing computer 10 includes at least one host processing processor 12 and at least one host processing memory 14. The host processing processor 12 is a central processing unit (CPU) as a processor capable of performing classical computation processing on data and capable of performing data transfer processing with at least the parallel processing computer 20 inside the system of the parallel processing computer 20 inside the system or the outside of the system. The host processing processor 12 reads a host program as a processing program from the host processing memory 14, and manages inputting, outputting, and processing of data and a program with the parallel processing computer 20 by transfer. The host processing processor 12 may manage inputting, outputting, and processing of data and a program with the outside of the system.

The host processing memory 14 is a semiconductor memory as a non-transitory tangible storage medium capable of non-transiently storing computer-readable data and programs. The host processing memory 14 stores a processing program including a host program that manages inputting, outputting, and processing of data with the parallel processing computer 20 and a kernel function called by the parallel processing computer 20. The host processing memory 14 stores input data input to the parallel processing computer 20, internal output data output inside the system from the parallel processing computer 20, and external output data that can be output to the outside of the system in accordance with the internal output data.

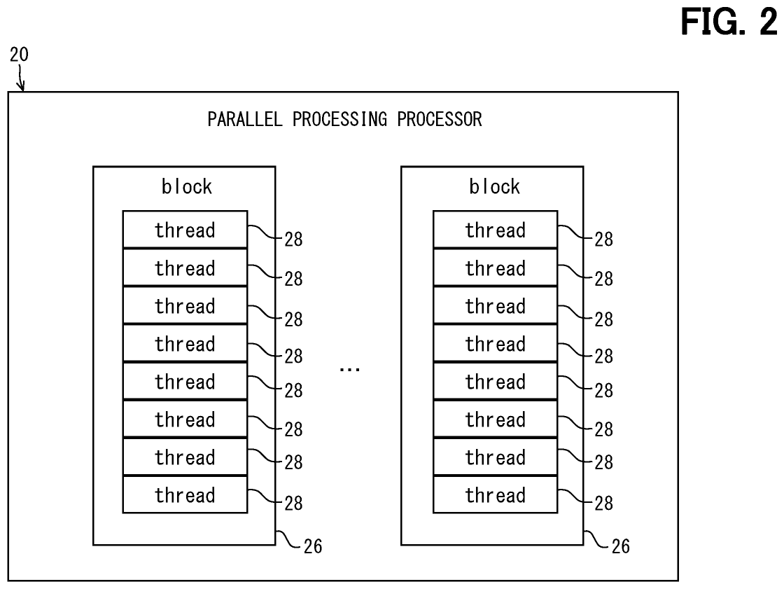

The parallel processing computer 20 includes at least one parallel processing processor 22 and at least one parallel processing memory 24. As shown in FIG. 2, the parallel processing processor 22 is a graphics processing unit (GPU) as a processor capable of constructing a plurality of threads 28 for each of a plurality of blocks 26 in order to solve an optimization problem by parallel processing of pseudo quantum computation. The parallel processing processor 22 calls a kernel function as a processing program from the host processing computer 10, and executes parallel processing for each thread 28 for each block 26.

The parallel processing memory 24 shown in FIG. 1 is a semiconductor memory as a non-transitory tangible storage medium capable of non-transiently storing computer-readable data and program. The parallel processing memory 24 stores a kernel function called from the host processing computer 10, and shares a memory area for parallel processing of each thread 28 for each block 26.

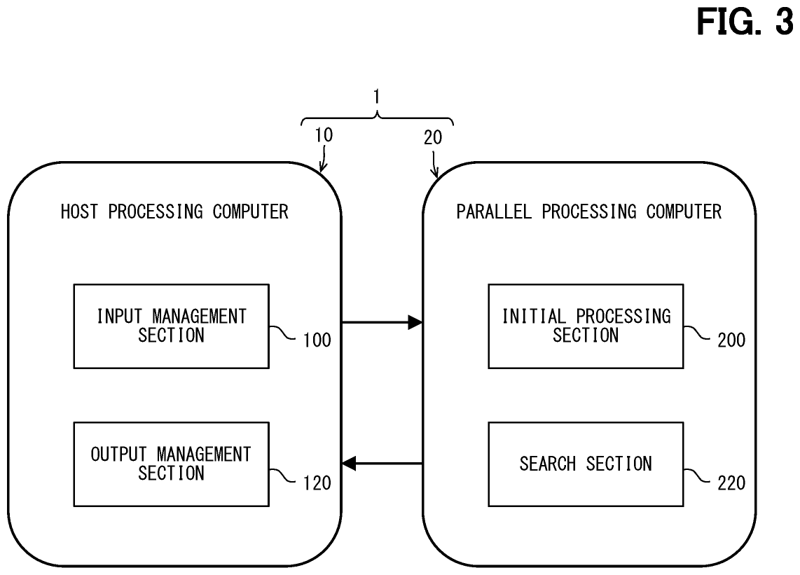

The processors 12 and 22 of the computers 10 and 20 in the processing system 1 construct a plurality of functional sections as shown in FIG. 3 by executing a host program and a kernel function as processing programs, respectively. Specifically, the host processing processor 12 constructs an input management section 100 and an output management section 120. In order to solve the combinatorial optimization problem in cooperation with these sections 100 and 120, the parallel processing processor 22 constructs an initial processing section 200 and a search section 220.

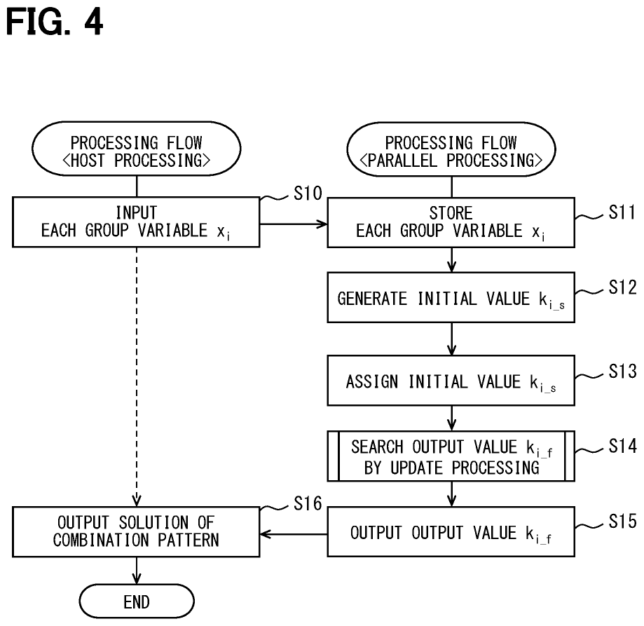

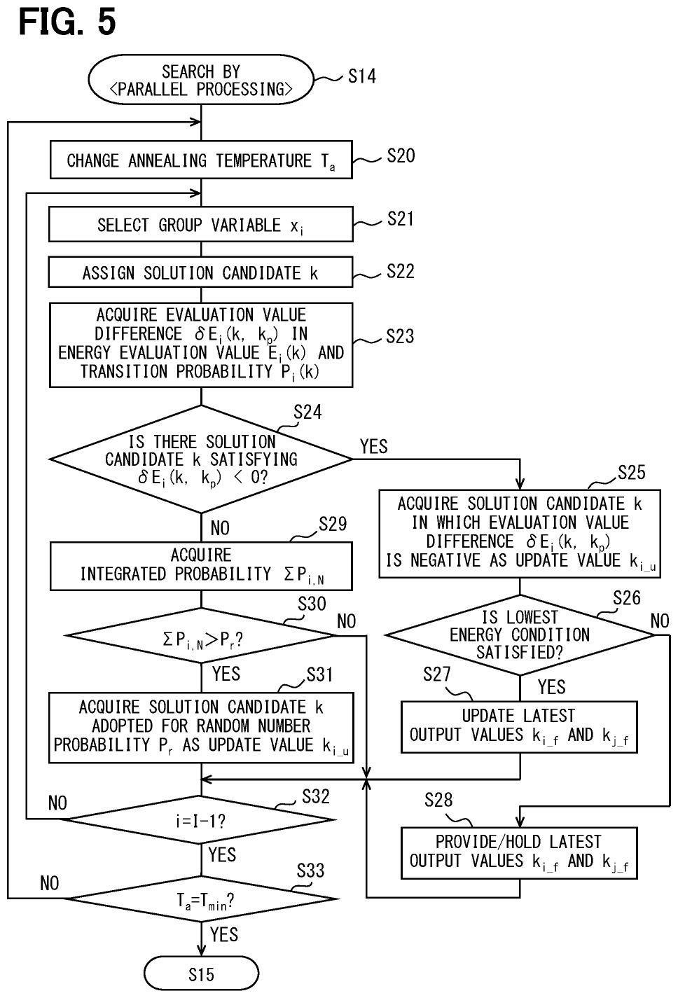

In this manner, the processors 12 and 22 of the computers 10 and 20 construct the respective functional sections, so that the processing method of solving the combinatorial optimization problem is performed in accordance with the processing flow shown in FIGS. 4 and 5. The processing flow is started in response to an instruction from, for example, a system operator or the outside of the system. Note that each “S” in the processing flow means a step to be subjected to sequence processing by a plurality of commands included in the processing program.

In S10 shown in FIG. 4, the input management section 100 manages data input from the host processing processor 12 to the parallel processing processor 22 by transfer between the computers 10 and 20 in cooperation with the initial processing section 200. Specifically, in the input management section 100 in S10, a binary variable is defined as a state variable that optimizes a combination pattern of solutions taking either 0 or 1 in the combinatorial optimization problem, that is, a combination state, by an energy function.

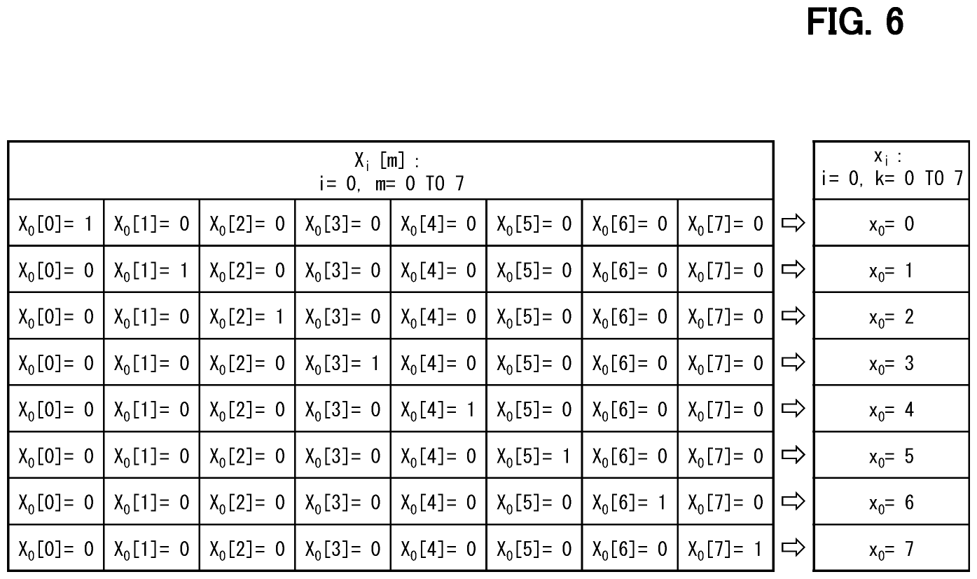

The binary variable X represented by Formula 1 in the combinatorial optimization problem of the present embodiment is grouped into a plurality of groups Gᵢ of a total number I in which an index i is defined as an integer by Formula 2. Then, the binary variable X is expressed as Xᵢ[m] assuming that M binary variables X are allocated to each group Gᵢ as in Formula 1 by using an index m defined as an integer by Formula 3. Furthermore, in each group Gᵢ, the one-hot constraint is given in which only one Xᵢ[m] in the same group Gᵢ takes 1 and M−1 Xᵢ[m] other than the one Xᵢ[m] in the same group Gᵢ take 0 as shown in Formula 4 and FIG. 6. Here, the number M of the binary variables Xᵢ[m] in each group Gᵢ is set so as to be the same in all the groups Gᵢ or different in at least one group Gᵢ from the other groups Gᵢ. For convenience of description, FIG. 6 exemplifies a combination pattern satisfying the one-hot constraint for M=8 binary variables X₀[m] in which m=0 to M−1 in the group G₀ with the index i=0. However, M is preferably set to an integer of two or more digits such as 1000, for example.

$$\{ X \} = \{ {X}_{i} [ m ] \} = {\underbrace{\{ {X}_{0} [ 0 ] , {X}_{0} [ 1 ] , , {X}_{0} [ M - 1 ] ,}}_{{G}_{0}} , {\underbrace{{X}_{I - 1} [ 0 ] , {X}_{I - 1} [ 1 ] , , {X}_{I - 1} [ M - 1 ] \}}}_{{G}_{I - 1}} \qquad ( Formula 1 )$$

$$i = 0 \sim I - 1 \qquad ( Formula 2 )$$

$$m = 0 \sim M - 1 \qquad ( Formula 3 )$$

$${\sum }_{m} {X}_{i} [ m ] = 1 \qquad ( Formula 4 )$$

The input management section 100 in S10 of FIG. 4 generates a group variable xᵢ for each group Gᵢ as input data to the parallel processing processor 22. Then, an index k is defined as a solution candidate k of the group variable xᵢ by being defined as an integer by Formula 5 so as to represent K combination patterns of the binary variable X₀[m] satisfying the one-hot constraint for each group Gᵢ.

k=0˜K−1 (Formula 5)

In the combinatorial optimization problem of the present embodiment, the number K of solution candidates k matching the number of combination patterns of the binary variables Xᵢ[m] for each group Gᵢ is set to an integer equal to or greater than three, which is the same as the number M of the binary variables Xᵢ[m] for each group Gᵢ. Therefore, each of the K solution candidates k for each group variable xᵢ is expressed as an integer by a multi bit index k as shown in FIG. 6. Here, the number K of the solution candidates k in each group Gᵢ is set so as to be the same in all the groups Gᵢ or different in at least one group Gᵢ from the other groups Gᵢ. For convenience of description, FIG. 6 shows an example in which K=8 solution candidates k of k=0 to K−1 are expressed by 3-bit integer index k for the group variable x₀ with the index i=0. However, K is preferably also set to an integer of two or more digits, so that the solution candidate k is expressed by the number of bits corresponding to the set value.

In this manner, in S10 of FIG. 4, the input management section 100 inputs each group variable xᵢ with the combination pattern of the binary variable Xᵢ[m] as the solution candidate k for each group Gᵢ by copy transfer to the parallel processing processor 22. In S11 following S10, the initial processing section 200 stores each group variable xᵢ input from the input management section 100 in the parallel processing memory 24.

In S12 following S11, the initial processing section 200 generates an initial value k_{i_s} of the solution candidate k for each group variable xᵢ. Here, parallel processing (described later) by the search section 220 is executed in parallel and simultaneously independently for each group variable xᵢ in a plurality of blocks 26. Then, the initial processing section 200 generates the initial value k_{i_s}, which is an integer of 0 to K−1, by random number generation for each group variable xᵢ from individual seed values of different blocks 26, and stores the generated initial value k_{i_s} in the parallel processing memory 24.

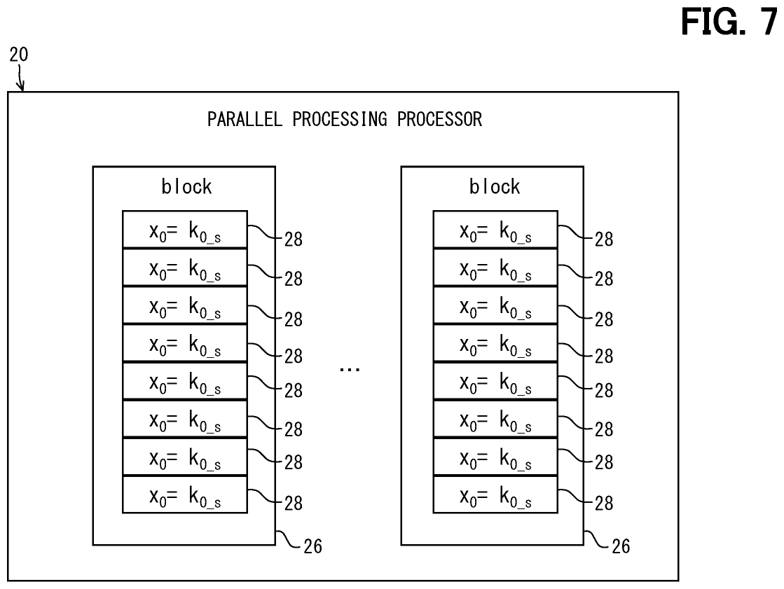

In S13 following S12, the search section 220 assigns the initial value k_{i_s} generated from different seed values individually associated with each block 26 in S12 to the threads 28 of the same block 26 in common as shown in FIG. 7. For convenience of description, FIG. 7 exemplifies a state in which the common initial value k_{0_s} is assigned to K=8 threads 28 in each block 26 for the group variable x₀ with the index i=0. However, by setting K to an integer of two or more digits as described above, the initial value kis common to the threads 28 of the number corresponding to the set value is preferably assigned. Although the initial values k_{0_s} of the different blocks 26 are indicated by using the same reference sign k_{0_s} in FIG. 7, the initial value k_{0_s} is actually a numerical value generated by random number generation from different seed values.

As illustrated in FIG. 4, in S14 following S13, the search section 220 searches by sequential update of an output value k_{i_f} for each group variable xᵢ by parallel processing in a plurality of blocks 26 associated with different seed values. In particular, the search section 220 in S14 of the first embodiment searches for the output value k_{i_f} from the solution candidate k for each thread 28 for each of all the group variables xᵢ by update processing in each block 26 based on an energy evaluation value and a transition probability as a selection rule according to simulated annealing. Note that in the following description of S14, unless otherwise specified, the search for the output value k_{i_f} in one block 26 will be mainly described in detail.

Specifically, in S14, S20 to S33 shown in FIG. 5 are executed. Here, particularly in S14, the output value k_{i_f} of each group variable xᵢ is searched for by repeating in S33 one sweep in which the update processing of repeating S21 to S31 as one flip in S32. First, in S20, the search section 220 sets an annealing temperature Tₐ common to all the group variables xᵢ between a maximum temperature and a minimum temperature Tₘᵢₙ (see S33 described later) so as to change from a set temperature (the maximum temperature at the first time) in the previous S20 by a predetermined temperature step. At this time, the temperature step is set to, for example, 1000 to 10000 steps.

In the following S21, the search section 220 sets the output value k_{i_f} as the group variable xᵢ for searching by updating the solution candidate k, and selects the group variable xᵢ in which the index i corresponding to the group Gᵢ is common to all the blocks 26 one by one in the order of the index i. Therefore, hereinafter, the group variable xᵢ selected in S21 is particularly referred to as a selected group variable xᵢ. The search section 220 in S21 as described above increments the index i to be initialized to 0 in the first update processing for the selected group variable xᵢ by one every time the second and subsequent update processing are started (that is, every time the processing flow returns from S32 described later).

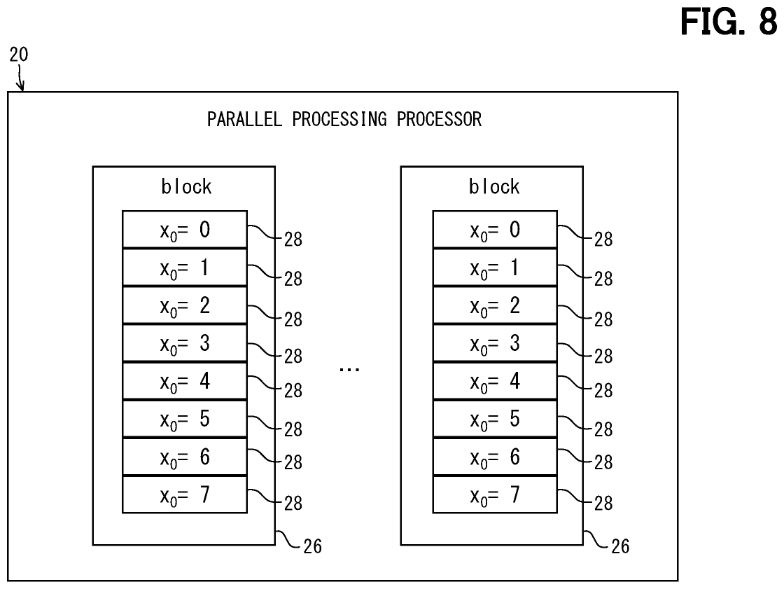

In the following S22, the search section 220 assigns K different solution candidates k to the selected group variable xᵢ of the index i in each block 26 for each of K threads 28 as shown in FIG. 8. For convenience of description, FIG. 8 exemplifies a state in which individual solution candidates k is assigned to K=8 threads 28 in each block 26 for the group variable x₀ with the index i=0. However, by setting K to an integer of two or more digits as described above, the solution candidates k are preferably assigned to the threads 28 of the number corresponding to the set value.

As shown in FIG. 5, in the following S23, the search section 220 acquires a difference in the energy evaluation value from before the update processing and the transition probability for the solution candidate k for each thread 28 related to the selected group variable xᵢ. Specifically, in the search section 220 in S23, a function Eᵢ(k) of the energy evaluation value for the solution candidate k for each thread 28 for the selected group variable xᵢ is defined by Formulas 6 and 7 according to a discrete quadratic model (DQM).

$${{{E}_{i} ( k ) ≡ E ( x ) \vert}_{{x}_{i} = k} = E ( {x}_{0} , {x}_{1} , … , {x}_{i} , … , {x}_{I - 1} ) \vert}_{{x}_{i} = k} \qquad ( Formula 6 )$$

$$E ( x ) ≡ E ( {x}_{0} , {x}_{1} , … , {x}_{I - 1} ) = {\sum }_{i = 0}^{I - 1} Q [ i \times K + {x}_{i} , i \times K + {x}_{i} ] + \frac{1}{2} {\sum }_{i \neq j} Q [ i \times K + {x}_{i} , j \times K + {x}_{j} ]$$

$$( where Q [ i \times K + {x}_{i} , j \times K + {x}_{j} ] = Q [ j \times K + {x}_{j} , i \times K + {x}_{i} ] ) \qquad ( Formula 7 )$$

In Formula 7, Q means a quadratic unconstrained binary optimization (QUBO) matrix. Here, a matrix coefficient of Q is preferably input together with each group variable xᵢ in S10 by being converted from the energy function for the binary variable Xᵢ[m]. In Formula 7, xⱼ represents a group variable with an index of j other than i to be distinguished from a group variable xᵢ with an index of i. Then, a unique solution candidate k is given to the selected group variable xᵢ for each thread 28. On the other hand, to the group variable xⱼ other than the selected group variable xᵢ, the latest value corresponding to the index j of the initial value k_{i_s} assigned in the most recent S13 or an update value k_{i_u} (described later) acquired in the past S25 and S31 is given. Note that in the following description and FIG. 5, the function Eᵢ(k) is expressed as an energy evaluation value Eᵢ(k).

In the search section 220 in S23, for each solution candidate k in each thread 28 for the selected group variable xᵢ, a difference in the energy evaluation value Eᵢ(k) from before the update processing is defined by a function δEᵢ(k, kₚ) of Formula 8. Here, in Formula 8, kₚ represents the solution candidate before the current update processing for the selected group variable xᵢ to be distinguished from the solution candidate k assigned in the most recent S22, which can be a candidate of the output value k_{i_f} after the current update processing. Then, the solution candidate kₚ is given the latest value corresponding to the index i of the selected group variable xᵢ of the initial value k_{i_s} assigned in the most recent S13 or the update value k_{i_u} acquired in the past S25 and S31.

$$δ {E}_{i} ( k , {k}_{p} ) ≡ {E}_{i} ( k ) - {E}_{i} ( {k}_{p} ) = ( {Σ}_{j = 0}^{I - 1} Q [ i \times K + {x}_{i} , j \times K + {x}_{j} ] ) {\vert}_{{x}_{i} = k} - ( {Σ}_{j = 0}^{I - 1} Q [ i \times K + {x}_{i} , j \times K + {x}_{j} ] ) {\vert}_{{x}_{i} = {k}_{p}} \qquad ( Formula 8 )$$

As a result, when the energy evaluation value Eᵢ(k) of the solution candidate k fluctuates to a smaller side than the energy evaluation value Eᵢ(kₚ) of the solution candidate kₚ, the difference represented by Formula 8 has a negative value. On the other hand, when the energy evaluation value Eᵢ(k) of the solution candidate k fluctuates to a greater side than the energy evaluation value Eᵢ(kₚ) of the solution candidate kₚ, the difference represented by Formula 8 is positive. Note that in the following description and FIG. 5, the function δEᵢ(k, kₚ) is expressed as an evaluation value difference δEᵢ(k, kₚ) which means a difference between the energy evaluation values Eᵢ(k).

In the search section 220 in S23, for each solution candidate k in each thread 28 for the selected group variable xᵢ, a transition probability corresponding to the evaluation value difference δEᵢ(k, kₚ) is defined by a function Pᵢ(k) of Formula 9. Note that in the following description and FIG. 5, the function Pᵢ(k) is expressed as a transition probability Pᵢ(k).

Pᵢ(k)=exp(−δEᵢ(k, kₚ)/Tₐ) (Formula 9)

Under the above definitions, in S23, the evaluation value difference δEᵢ(k, kₚ) and the transition probability Pᵢ(k) based on the energy evaluation value Eᵢ(k) are acquired by parallel computation in the plurality of threads 28 for each solution candidate k for the selected group variable xᵢ. Then, the acquired values δEᵢ(k, kₚ) and Pᵢ(k) for each thread 28 in S23 are stored in the parallel processing memory 24.

In the following S24, the search section 220 determines the presence or absence of a solution candidate k in which the evaluation value difference δEᵢ(k, kₚ) from before the update processing acquired in the most recent S23 is negative (that is, δEᵢ(k, kₚ)<0). As a result, when an affirmative determination is made because the evaluation value difference δEᵢ(k, kₚ) corresponding to at least one solution candidate k is negative, the processing flow proceeds to S25.

In S25, the search section 220 acquires, as the update value k_{i_u}, a solution candidate k in which the evaluation value difference δEᵢ(k, kₚ) is the largest in a negative direction of at least one solution candidate k in which the evaluation value difference δEᵢ(k, kₚ) is negative. Here, the update value k_{i_u} means an update processing result for searching for the output value k_{i_f} of the selected group variable xᵢ. At this time, in particular, when the solution candidate k in which the evaluation value difference Eᵢ(k, kₚ) is negative is singular, the singular solution candidate k corresponds to the update value k_{i_u} in which the evaluation value difference δEᵢ(k, kₚ) is the largest in the negative direction. In S25 as described above, the energy evaluation value Eᵢ(k) is acquired on the basis of the evaluation value difference δEᵢ(k, kₚ) for the solution candidate k giving the update value k_{i_u}, and is stored in the parallel processing memory 24 in association with the update value k_{i_u}.

In the following S26, the search section 220 determines whether a lowest energy condition is satisfied in which the energy evaluation value Eᵢ(k) acquired in the most recent S25 is less than the energy evaluation value Eᵢ(k) acquired in the past S25. When an affirmative determination is made as a result, the processing flow proceeds to S27.

In S27, the search section 220 updates the output value k_{i_f} of the selected group variable xᵢ in the parallel processing memory 24 by the update value k_{i_u} in the most recent S25. That is, the update value k_{i_u} corresponding to the energy evaluation value Eᵢ(k) having the smallest value in the update processing from the past to the present is selected as the latest output value k_{i_f} for the selected group variable xᵢ. Furthermore, in S27, as the latest output value k_{i_f} for the group variable xⱼ other than the selected group variable xᵢ, the latest value corresponding to the index j of the initial value k_{i_s} assigned in the most recent S13 or the update values k_{i_u} acquired in the past S25 and S31 is provided or held in the parallel processing memory 24. In S27 as described above, as the energy evaluation value Eᵢ(k) corresponding to the latest output values k_{i_f} and k_{j_f}, the energy evaluation value Eᵢ(k) acquired in the most recent S25 is updated in the parallel processing memory 24.

On the other hand, when a negative determination is made in S26, the processing flow proceeds to S28. In S28, the search section 220 provides or holds, as the latest output value k_{i_f} for the selected group variable xᵢ, the latest value corresponding to the index i of the initial value k_{i_s} assigned in the most recent S13 or the output value k_{i_f} updated in the past S27 in the parallel processing memory 24. That is, the output value k_{i_f} of the selected group variable xᵢ is not updated depending on the update value k_{i_u} corresponding to the energy evaluation value Eᵢ(k) greater than the smallest value in the past update processing. Furthermore, in S28, as the latest output value k_{i_f} for the group variable xⱼ other than the selected group variable xᵢ, the latest value corresponding to the index j of the initial value k_{i_s} assigned in the most recent S13 or the update values k_{i_u} acquired in the past S25 and S31 is provided or held in the parallel processing memory 24.

When a negative determination is made in S24 for S25 to S28 as described above, it is determined that the evaluation value difference δEᵢ(k, kₚ) from before the update processing acquired in the most recent S23 is positive for all the solution candidates k (that is, δEᵢ(k, kₚ)>0), and the processing flow proceeds to S29. In S29, the search section 220 acquires an integrated probability ΣP_{i,N} by integrating the transition probability Pᵢ(k) acquired in the most recent S23 for a limited number N of solution candidates k of all the K solution candidates in which the evaluation value difference δEᵢ(k, kₚ) is positive. At this time, the limited number N of the solution candidates k is defined as an integer smaller than a total number K of the solution candidates k so that the integrated probability (that is, a sum probability) ΣP_{i,N} obtained by integrating the transition probability Pᵢ(k) from a high probability side is less than one.

In the following S30, the search section 220 compares the integrated probability ΣP_{i,N} acquired in the most recent S29 with a uniformly distributed random number probability Pᵣ. At this time, the random number probability Pᵣ is defined as a uniform random number in which random numbers generated in a fractional range of 0 to 1 are distributed with uniformity. Then, the search section 220 in S30 determines whether the integrated probability ΣP_{i,N} exceeds the random number probability Pᵣ. When an affirmative determination is made as a result, the processing flow proceeds to S31.

In S31, the search section 220 acquires, as the update value k_{i_u} of the selected group variable xᵢ, the solution candidate k adopted for the random number probability Pᵣ among the limited number N of solution candidates k in a case where the integrated probability ΣP_{i,N} exceeds the random number probability Pᵣ. Then, in S31, the energy evaluation value Eᵢ(k) is acquired on the basis of the evaluation value difference δEᵢ(k, kₚ) for the solution candidate k giving the update value k_{i_u}, and is stored in the parallel processing memory 24 in association with the update value k_{i_u}. The energy evaluation value Eᵢ(k) stored in S31 is used as a computation reference value to which a negative or positive evaluation value difference δEᵢ(k, kₚ) is added in order to acquire the energy evaluation value Eᵢ(k) in the next step of S31 or S25. The same applies to the energy evaluation value Eᵢ(k) stored in S25 described above.

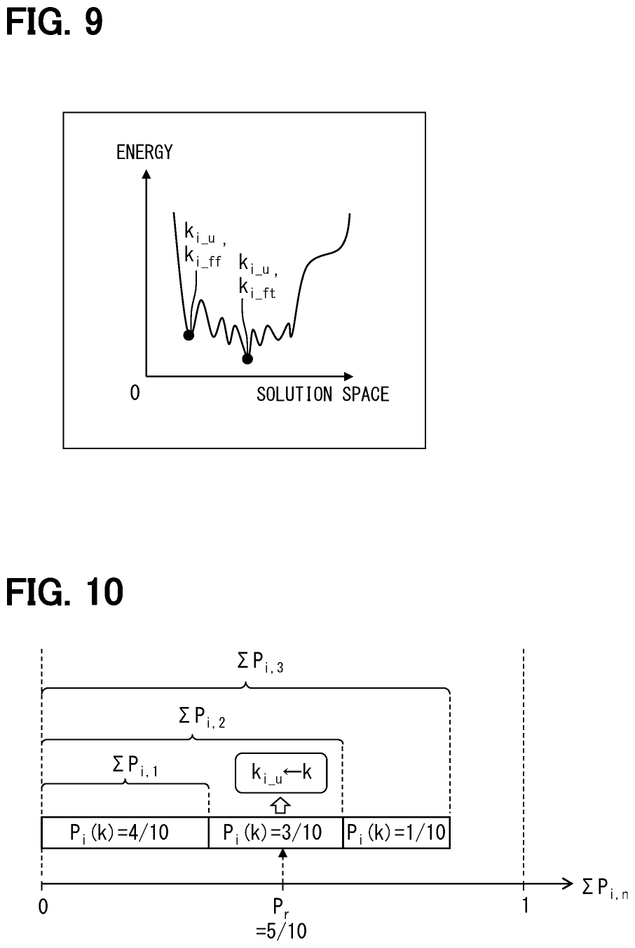

Here, in S31, a case is assumed where the update value k_{i_u} in S25 is updated as the output value k_{i_f} in S27 even when the update value k_{i_u} is a value k_{i_ff} that gives a false local solution as shown in FIG. 9. In this assumed case, S31 is executed to continue the search for the value k_{i_ft} that gives a true global solution as shown in FIG. 9 as the output value kir by once returning the negative evaluation value difference δEᵢ(k, kₚ) in a positive direction and then shifting the evaluation value difference δEᵢ(k, kₚ) again in the negative direction.

Specifically, as for the limited number N of solution candidates k, the search section 220 in S31 compares a cumulative sum ΣP_{i,n} obtained by changing an integration number (that is, an integration section from a high probability side) n of the transition probability Pᵢ(k) by one in an integer range of 1 to N as shown in FIG. 10 with the same random number probability Pᵣ as the random number probability Pᵣ in the most recent S30. Then, in S31, an n-th solution candidate k from the high probability side in which the cumulative sum ΣP_{i,n} exceeds the random number probability Pᵣ as shown in FIG. 10 is acquired as the update value k_{i_u} adopted for the probability Pᵣ, and accordingly, stored in the parallel processing memory 24 in response to being. FIG. 10 shows an example in which a cumulative sum ΣP_{i,2} of a second transition probability Pᵢ(k) from the high probability side exceeds the random number probability Pᵣ with the limited number N=3, and thus, the solution candidate k of the second transition probability Pᵢ(k) is acquired as the update value k_{i_u} adopted for the probability Pᵣ.

As shown in FIG. 5, after the execution of any of S27, S28, or S31 is completed, the processing flow proceeds to S32. When a negative determination is made in S30, the processing flow proceeds to S32. In S32, the search section 220 determines whether the index i of the selected group variable xᵢ is I−1. As a result, when a negative determination is made, the processing flow returns to S21, and when an affirmative determination is made, the processing flow proceeds to S33. Thus, the update processing in S21 to S31 is repeated for all the group variables xᵢ.

In S33, the search section 220 determines whether the annealing temperature Tₐ has reached the minimum temperature Tₘᵢₙ. As a result, when a negative determination is made, the processing flow returns to S20 to continue the simulated annealing in which the annealing temperature Tₐ is reduced and changed for each group variable xᵢ. On the other hand, when an affirmative determination is made, it is determined that the simulated annealing in S14 has been completed, and the processing flow proceeds from S14 to S15.

As described above, in the completion stage of S14, the latest output value k_{i_f} stored in the parallel processing memory 24 for each group variable xᵢ is confirmed as a search result. At this time, the output values k_{i_f} and k_{i_f} updated for the selected group variable xᵢ and the other group variables xⱼ in the most recent (that is, the last) S27 is the output value k_{i_f} confirmed for each group variable xᵢ in the completion stage of S14.

As shown in FIG. 4, in cooperation with the output management section 120, the search section 220 manages data to be output from the parallel processing processor 22 to the host processing processor 12 by transfer between the computers 20 and 10 in S15. Specifically, the search section 220 in S15 outputs a set of the output values k_{i_f} searched for each of all the group variables xᵢ in S14 as an executable solution by copy transfer to the host processing processor 12.

In S16 following S15, the output management section 120 maps the output values k_{i_f} of all the group variables xᵢ output as the executable solutions from the parallel processing processor 22 to a solution space according to the energy function for the binary variable Xᵢ[m]. As a result, the output management section 120 in S16 outputs a solution (that is, an optimal combination solution) in which the combination pattern of the binary variable Xᵢ[m] is optimized so as to satisfy the one-hot constraint for each group Gᵢ.

The output in S16 may be outputting and storing a solution to the host processing memory 14 so as to be readable by access from the outside of the system. In this case, the processing system 1 may include at least one type of a server system, a remote management system, mobility, or the like that uses an output solution from the host processing computer 10. The output in S16 may be outputting a solution by copy transfer to the outside of the system. In this case, the outside of the system may be, for example, at least one type of a server system that is communicable with the processing system 1, mobility equipped with the processing system 1, or the like that uses an output solution from the host processing computer 10. As described above, the current execution of the processing flow terminates when the execution of S16 is completed.

As described above, in the first embodiment in which the group variable xᵢ with the combination pattern satisfying the one-hot constraint for each group Gᵢ of the binary variable Xᵢ[m] as the solution candidate k is defined, the solution candidate k is assigned for each thread 28 in each block 26 of the parallel processing processor 22. Therefore, in the first embodiment, the output value k_{i_f} of the group variable xᵢ is searched for on the basis of the energy evaluation value Eᵢ(k) for the solution candidate k of the group variable xᵢ assigned for each thread 28 in each block 26. Accordingly, the output value k_{i_f} of the group variable xᵢ is searched in parallel in each block 26, and thus, the search that can ensure accuracy can be completed in a short time. Here, the output values k_{i_f} of all the group variables xᵢ output by the search are equivalent to a solution in which the combination pattern is optimized so as to satisfy the one-hot constraint for each group Gᵢ of the binary variable Xᵢ[m]. Therefore, the first embodiment is effective in achieving both an increase in speed of solving processing and an improvement in solving accuracy.

In each block 26 according to the first embodiment, a solution candidate k is assigned to each thread 28, the solution candidate being obtained by expressing, as an integer, a combination pattern satisfying the one-hot constraint for each group Gᵢ of the binary variable Xᵢ[m] by a multi bit index k. Accordingly, even if the number of solutions of the combination pattern to be optimized increases, the search for the output value k_{i_f} with which accuracy can be ensured in each block 26 can be completed in a short time in parallel on the basis of the energy evaluation value Eᵢ(k) for the solution candidate k expressed as an integer with the number of bits corresponding to the number of solutions. Therefore, the first embodiment can contribute to both an increase in the speed of the solving processing and an improvement in the solving accuracy.

In each block 26 according to the first embodiment, the processing of assigning the solution candidate k of the same group variable xᵢ for each thread 28 is repeated for all the group variables xᵢ. Accordingly, the search for the output value k_{i_f} that can be completed in a short time by the parallel processing in each block 26 is repeated for all the group variables xᵢ, and thus, it is possible to output the output value k_{i_f} of all the group variables xᵢ with high accuracy. Therefore, the first embodiment is particularly effective in improving the solving accuracy together with increasing the speed of the solving processing.

In each block 26 according to the first embodiment, the output value k_{i_f} is searched for by update processing based on not only the energy evaluation value Eᵢ(k) for the solution candidate k of the group variable xᵢ assigned to each thread 28 but also the transition probability Pᵢ(k) for the solution candidate k. Accordingly, since the search accuracy of the output value k_{i_f} can be improved, it is particularly effective for improving the solving accuracy together with increasing the speed of the solving processing.

In each block 26 according to the first embodiment, the output value k_{i_f} is updated from the solution candidate k for each thread 28 in which the evaluation value difference δEᵢ(k, kₚ) in the energy evaluation value Eᵢ(k) from before the update processing and the transition probability Pᵢ(k) corresponding to the difference δEᵢ(k, kₚ) are acquired in accordance with the simulated annealing. Accordingly, the search for the output value k_{i_f} according to the simulated annealing can be completed in a short time by the update processing based on the evaluation value difference δEᵢ(k, kₚ) and the transition probability Pᵢ(k) limited to the solution candidate k for each thread 28. Therefore, the first embodiment is particularly effective in increasing the speed of the solving processing together with improving the solving accuracy.

In each block 26 according to the first embodiment, the solution candidate k in which the evaluation value difference δEᵢ(k, kₚ) in the energy evaluation value Eᵢ(k) is the largest in the negative direction is acquired as the update value k_{i_u} for searching for the output value k_{i_f}. Accordingly, the output value k_{i_f} that optimizes the energy evaluation value Eᵢ(k) for each group variable xᵢ can be searched with high accuracy and in a short time by the update based on the evaluation value difference δEᵢ(k, kₚ). Therefore, the first embodiment can contribute to both an increase in the speed of the solving processing and an improvement in the solving accuracy.

In each block 26 according to the first embodiment, the integrated probability ΣP_{i,N} obtained by integrating the transition probability Pᵢ(k) is compared with the uniformly distributed random number probability Pᵣ for the limited number N of solution candidates k from the high probability side among the solution candidates k in which the evaluation value difference δEᵢ(k, kₚ) in the energy evaluation value Eᵢ(k) is positive. As a result, the search for the output value k_{i_f} is continued by using, as the update value k_{i_u}, the solution candidate k of the transition probability Pᵢ(k) adopted as the random number probability Pᵣ among the limited number N of solution candidates k in a case where the integrated probability ΣP_{i,N} exceeds the random number probability Pᵣ. Accordingly, since the solution candidate k in which the evaluation value difference δEᵢ(k, kₚ) becomes negative next even if the evaluation value difference δEᵢ(k, kₚ) becomes positive once can be updated on the basis of the transition probability Pᵢ(k) of the number N limited from the high probability side, the output value k_{i_f} can be searched for with high accuracy for each group variable xᵢ. Therefore, in the first embodiment, it is possible to ensure improvement in high solving accuracy while achieving an increase in the speed of the solving processing.

In the first embodiment, the group variable xᵢ in which the combination pattern satisfying the one-hot constraint for each group Gᵢ of the binary variable Xᵢ[m] is set as the solution candidate k is input from the host processing processor 12 to the parallel processing processor 22. As a result, the output values k_{i_f} of all the group variables xᵢ output from the parallel processing processor 22 are output in accordance with mapping of the combination pattern of the binary variables Xᵢ[m] to an optimized solution so as to satisfy the one-hot constraint for each group Gᵢ in the host processing processor 12. Accordingly, the parallel processing processor 22 specialized for the search for the output value k_{i_f} of the group variable xᵢ in a short time with which accuracy can be secured can cause the host processing processor 12 to share the functions of the input of the group variable xᵢ and the solution output of the combination pattern from the output value k_{i_f}. Therefore, the first embodiment is particularly effective in increasing the speed of the solving processing together with improving the solving accuracy.

### Second Embodiment

A second embodiment is a modification of the first embodiment.

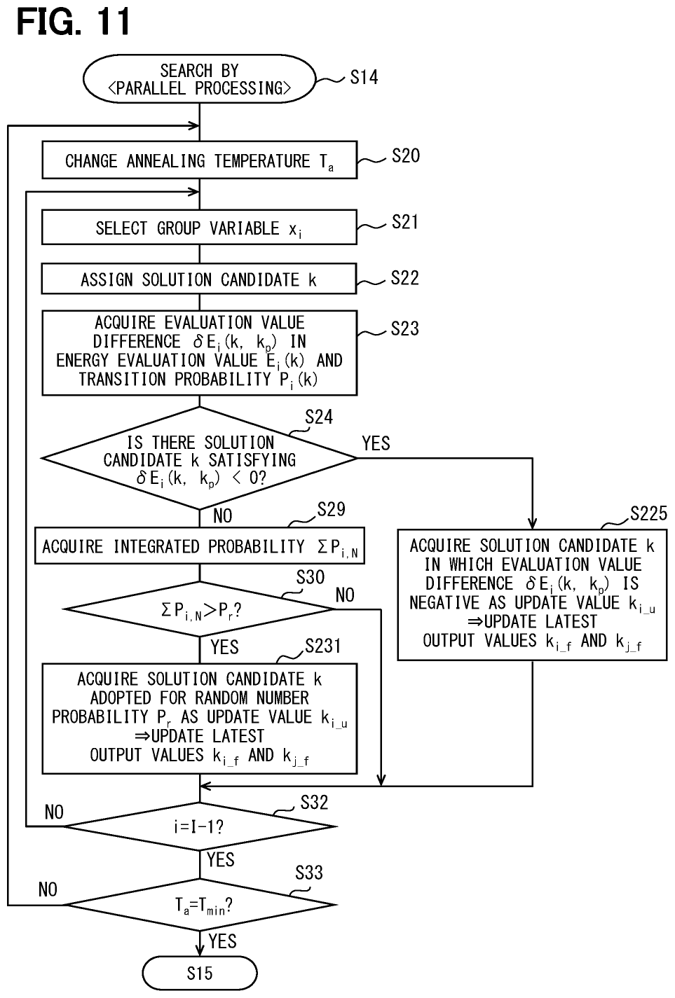

As shown in FIG. 11, in the processing flow of the second embodiment, S26 to S28 of the first embodiment are skipped, and S225 and S231 in place of S25 and S31 of the first embodiment, respectively, are executed. Note that S225 and S231 are executed in a similar manner to S25 and S31 of the first embodiment except for the processing described below.

Specifically, in both S225 and S231, the search section 220 updates the output value k_{i_f} of the selected group variable xᵢ in the parallel processing memory 24 by the acquired update value k_{i_u}. That is, the update value k_{i_u} acquired in S225 and S231 is directly selected as the latest output value k_{i_f} for the selected group variable xᵢ. Furthermore, in S225 and S231, as the latest output value k_{i_f} for the group variable xⱼ other than the selected group variable xᵢ, the latest value corresponding to the index j of the initial value k_{i_s} assigned in the most recent S13 or the update values k_{i_u} acquired in the past S225 and S231 is provided or held in the parallel processing memory 24. In S225 and S231 as described above, as the energy evaluation value Eᵢ(k) corresponding to the latest output values k_{i_f} and k_{j_f}, the energy evaluation value Eᵢ(k) acquired in accordance with the S25 and S31 is updated in the parallel processing memory 24.

In the processing flow of the second embodiment, in S14 including S225 and S231 described above, the latest output value k_{i_f} stored in the parallel processing memory 24 for each group variable xᵢ is confirmed as a search result. At this time, the output values k_{i_f} and k_{j_f} updated for the selected group variable xᵢ and the other group variables xⱼ in the most recent (that is, the last) step of S225 or S231 is the output value k_{i_f} confirmed for each group variable xᵢ in the completion stage of S14. Therefore, the second embodiment described above also enables exhibition of the operational effects similar to those of the first embodiment.

### Third Embodiment

A third embodiment is a modification of the second embodiment.

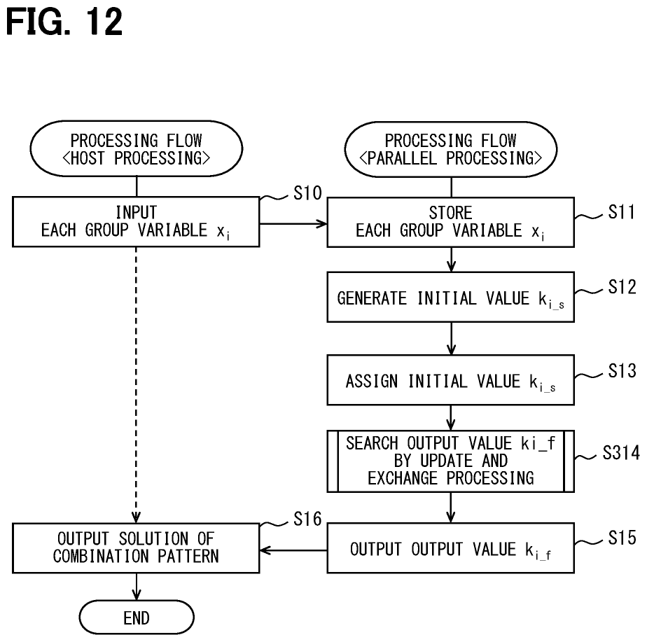

As shown in FIG. 12, in a processing flow of the third embodiment, S314 is executed instead of S14 of the first embodiment. In S314, the search section 220 searches for the output value k_{i_f} from the solution candidate k for each thread 28 for every group variable xᵢ by update processing in each block 26 based on the energy evaluation value Eᵢ(k) and the transition probability Pᵢ(k) and exchange processing between the blocks 26 according to a replica exchange method.

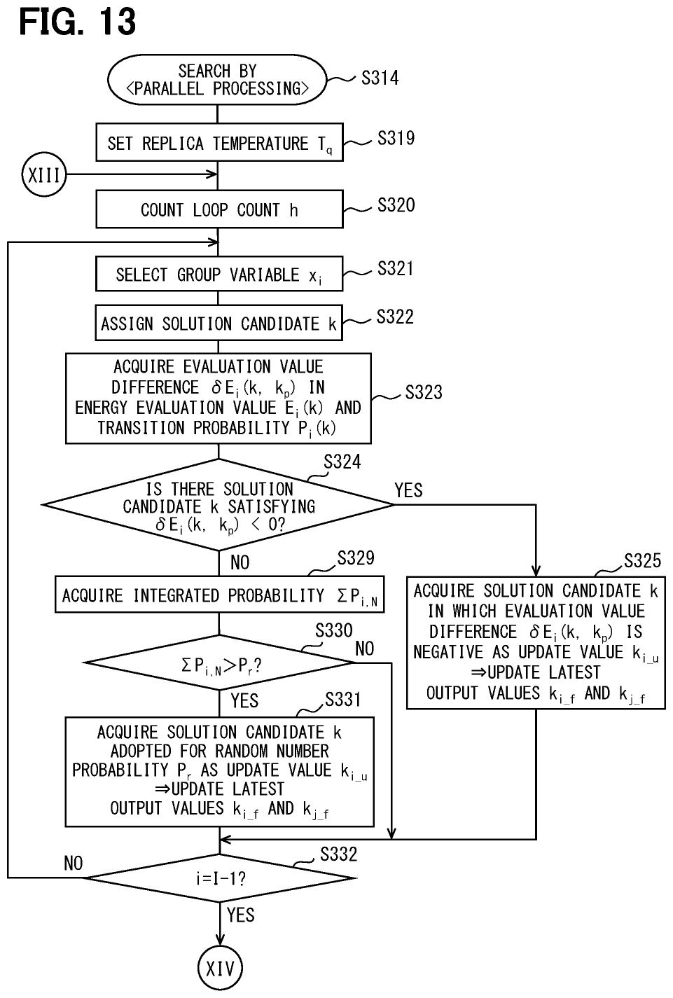

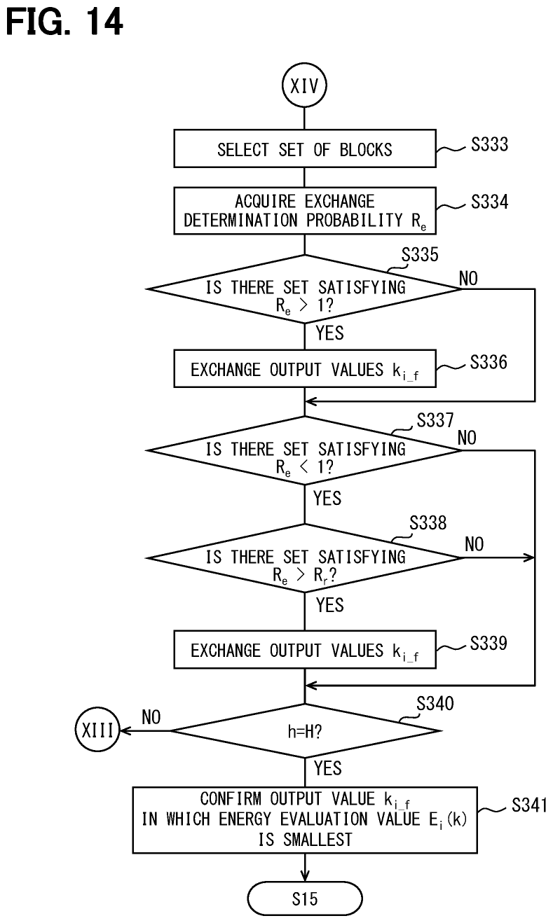

Specifically, in S314, S319 to S341 shown in FIGS. 13 and 14 are executed. Here, in S314 in particular, the output value k_{i_f} confirmed in S341 is searched for each group variable xᵢ by repeating in S340 search processing in which one loop is from the repetition of the update processing of S321 to S331 in S332 to the exchange processing of S333 to S339.

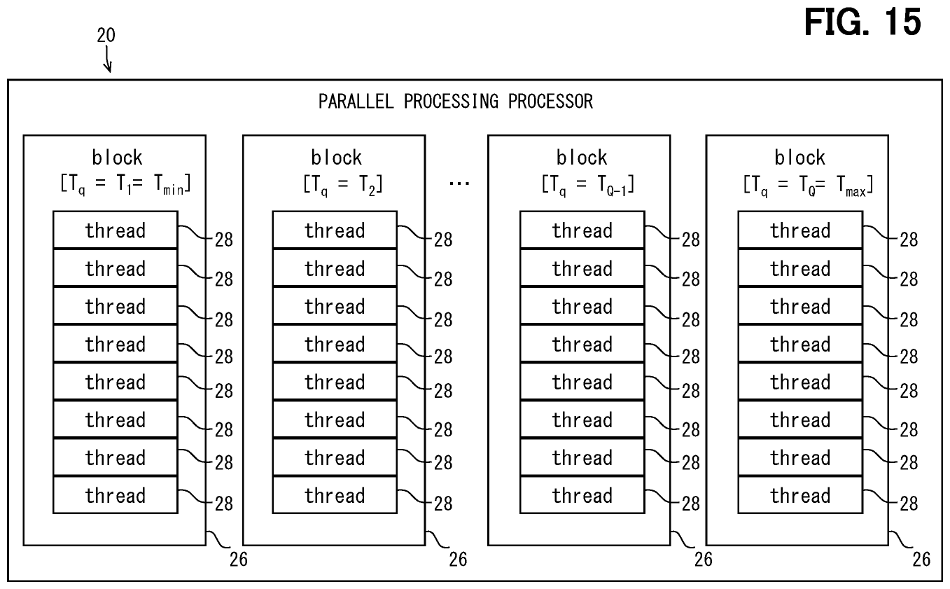

In S319 shown in FIG. 13, the search section 220 individually sets a replica temperature common to all the group variables xᵢ for each block 26 between a minimum temperature Tₘᵢₙ and a maximum temperature Tₘₐₓ as shown in FIG. 15. At this time, the replica temperature is set to different temperatures T_{q} between the blocks 26, in which the temperature T_{q} of an index q is defined as an integer by Formula 10 for each of the blocks 26 which can be Q replicas. Here, in the third embodiment, a larger temperature T_{q} is uniquely set as the replica temperature for a block 26 having a larger index q. Therefore, hereinafter, the temperature To unique to each block 26 is also referred to as a replica temperature T_{q}. The replica temperature T_{q} of each block 26 is set in a temperature range from 1 kelvin (K) as the minimum temperature Tₘᵢₙ to 1000K as the maximum temperature Tₘₐₓ, for example. Furthermore, the number Q of blocks 26 in which different replica temperatures T_{q} are set is set to, for example, 100 to 1000 or the like.

q=1˜Q (Formula 10)

In S320 following S319, the search section 220 counts a loop count h of the search processing in S321 to S339 shown in FIGS. 13 and 14 in order from 1. The search section 220 in S320 as described above increments the loop count h initialized to one in the first search processing by one every time the second and subsequent search processing are started (that is, every time the processing flow returns from S340 described later).

As shown in FIGS. 13, S321 to S332 following S320 are executed by replacing the annealing temperature Tₐ with the replica temperature T_{q} in accordance with S21 to S24, S225, S26 to S30, S231, and S32 described in the first and second embodiments. Therefore, as a subsequent step when an affirmative determination is made in S332, S333 to S341 are executed in the third embodiment as shown in FIG. 14.

Specifically, in S333, the search section 220 selects a set of blocks 26 in which replica temperatures T_{q} and T_{q+1} are adjacent to each other such that the same block 26 does not overlap between the sets. When the loop count h of the search processing counted in the most recent S333 is an odd number, the search section 220 in S320 as described above selects a set of blocks 26 corresponding to the replica temperatures T_{q} and T_{q+1} in which q is an odd number and q+1 is an even number. On the other hand, when the loop count h of the search processing counted in the most recent S333 is an even number, the search section 220 in S320 as described above selects a set of blocks 26 corresponding to the replica temperatures T_{q} and T_{q+1} in which q is an even number and q+1 is an odd number.

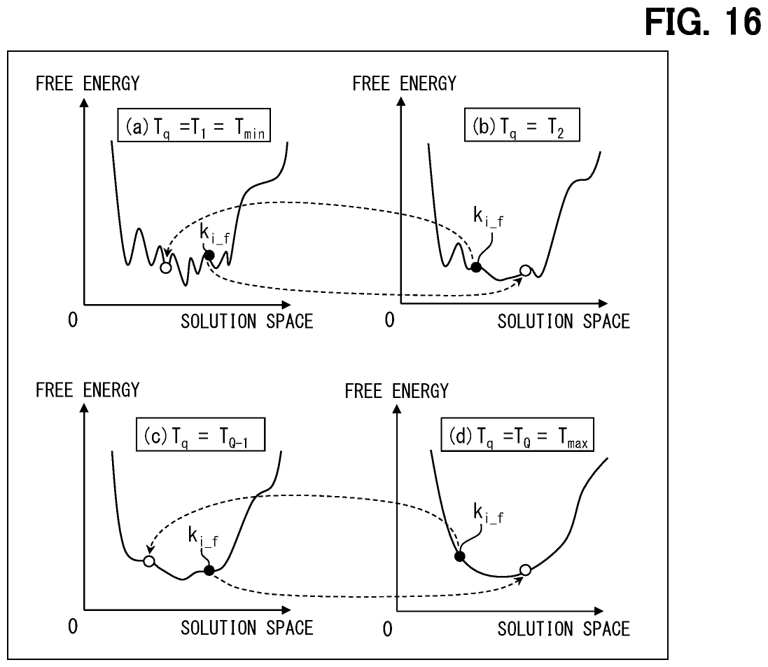

In the following S334, the search section 220 acquires an exchange determination probability Rₑ of Formula 11 as a determination criterion for exchanging the latest output value k_{i_f} stored in the parallel processing memory 24 for each group variable xᵢ between the plurality of sets of blocks 26 selected in the most recent S333 as shown in FIG. 16. In Formula 11, Eq and E_{q+1} represent the energy evaluation values Eᵢ(k) for the latest output value k_{i_f} selected by the block 26 of the corresponding replica temperatures T_{q} and T_{q+1} of the indexes, respectively.

$${R}_{e} = exp ( ( \frac{1}{{T}_{q}} - \frac{1}{{T}_{q + 1}} ) \cdot ( {E}_{q} - {E}_{q + 1} ) ) \qquad ( Formula 11 )$$

In the following S335, the search section 220 determines the presence or absence of a set of blocks 26 in which the exchange determination probability Rₑ acquired in the most recent S334 exceeds one (that is, Rₑ>1). As a result, when an affirmative determination is made because the exchange determination probability Rₑ between at least one set of blocks 26 exceeds one, it is determined that an exchange condition based on the energy evaluation value Eᵢ(k) is satisfied, and the processing flow proceeds to S336.

In S336, the search section 220 exchanges the latest output values k_{i_f} for each group variable xᵢ between at least one set of blocks 26 in which the exchange determination probability Rₑ exceeds one (examples of a part (a) and a part (b) of FIG. 16). Then, in S336, the exchanged output value k_{i_f} in each block 26 is updated again as the latest output value k_{i_f} stored in the parallel processing memory 24. Furthermore, in S336, the energy evaluation value Eᵢ(k) corresponding to the latest output value k_{i_f} is acquired again and updated again in the parallel processing memory 24.

On the other hand, as shown in FIG. 14, when a negative determination is made in S335, the processing flow proceeds to S337. After completion of the execution of S336, the processing flow also proceeds to S337. In S337, the search section 220 determines the presence or absence of a set of blocks 26 in which the exchange determination probability Rₑ acquired in the most recent S334 is less than one (that is, Rₑ <1). As a result, when an affirmative determination is made because the exchange determination probability Rₑ between at least one set of blocks 26 is less than one, the processing flow proceeds to S338.

In S338, the search section 220 compares the exchange determination probability Rₑ acquired in the most recent S334 with a uniformly distributed random number probability Rᵣ. At this time, the random number probability Rᵣ is defined as a uniform random number in which random numbers generated in a fractional range of 0 to 1 are distributed with uniformity. Therefore, the search section 220 in S338 determines whether the presence or absence of a set of blocks 26 in which the exchange determination probability Rₑ exceeds the random number probability Rᵣ.

When an affirmative determination is made in S338, it is determined that another exchange condition based on the energy evaluation value Eᵢ(k) is satisfied, and the processing flow proceeds to S339. In S339, the search section 220 exchanges the latest output values k_{i_f} for each of all the group variables xᵢ between at least one set of blocks 26 exceeding the random number probability Rᵣ even if the exchange determination probability Rₑ is less than one (examples of a part (c) and a part (d) of FIG. 16). Then, in S339, the exchanged output value k_{i_f} in each block 26 is updated again as the latest output value k_{i_f} stored in the parallel processing memory 24. Furthermore, in S339, the energy evaluation value Eᵢ(k) corresponding to the latest output value k_{i_f} is acquired again and updated again in the parallel processing memory 24.

As shown in FIG. 14, after completion of the execution of S339, the processing flow proceeds to S340. When a negative determination is made in any of S337 or 338, the processing flow proceeds to S340. In S340, the search section 220 determines whether the loop count h of the current search processing in S314 has reached an upper limit number H. Here, the upper limit number H is set to the loop count h of 1000 to 10000 times or the like.

When a negative determination is made in S340, the processing flow returns to S320 as shown in FIGS. 13 and 14, and the search processing is continued. On the other hand, when an affirmative determination is made in S340, the processing flow proceeds to S341 as shown in FIG. 14. In S341, the search section 220 determines, as a search result, the output value k_{i_f} in which the energy evaluation value Eᵢ(k) corresponding to the latest output value k_{i_f} stored for each group variable xᵢ in the parallel processing memory 24 is the smallest of all the blocks 26. It is determined that the search processing is also completed by completion of the execution of S341 as described above, and the processing flow proceeds from S314 to S15 as shown in FIGS. 12 and 14.

In the third embodiment described so far, in each block 26 as a replica of different temperatures T_{q}, together with the evaluation value difference δEᵢ(k, kₚ) in the energy evaluation value Eᵢ(k) from before the update processing, the output value k_{i_f} is updated from the acquired solution candidates k for each thread 28 of the transition probability Pᵢ(k) corresponding to the difference δEᵢ(k, kₚ). Then, in the third embodiment, the output values k_{i_f} for which the exchange condition based on the energy evaluation value Eᵢ(k) is satisfied are exchanged between the blocks 26 of the adjacent temperatures T_{q} in accordance with the replica exchange method. Accordingly, the search for the output value k_{i_f} with high accuracy can be completed in a short time by the exchange processing between the blocks 26 in which the update processing of the output value k_{i_f} has been individually performed. Therefore, the third embodiment can contribute to both an increase in the speed of the solving processing and an improvement in the solving accuracy.

### OTHER EMBODIMENTS

Although a plurality of embodiments have been described above, the present disclosure is not to be construed as being limited to these embodiments, and can be applied to various embodiments and combinations without departing from the gist of the present disclosure.

The dedicated computer constituting the host processing computer 10 and/or the parallel processing computer 20 in a modification of the first to third embodiments may include at least one of a digital circuit or an analog circuit as a processor. Here, the digital circuit is, for example, at least one type of an application specific integrated circuit (ASIC), a field programmable gate array (FPGA), a system on a chip (SOC), a programmable gate array (PGA), a complex programmable logic device (CPLD), or the like. Such a digital circuit may include a memory storing a program. The memory may be a non-transitory computer readable storage medium.

In a modification of the first to third embodiments, each of the computers 10 and 20 may be implemented in a form of an individual or integrated semiconductor unit (for example, a semiconductor chip or the like). In a modification of the first to third embodiments, the functions of the host processing computer 10 may be integrated into the parallel processing computer 20. In a modification of the first to third embodiments, K=2 solution candidates k may be expressed by a single bit index k.

In a modification of the first to third embodiments, the energy evaluation value Eᵢ(k) may be acquired every time S23 is executed. In a modification of the third embodiment, steps equivalent to S26 to S28 of the first embodiment may be added between S325 and S332. In a modification of the third embodiment, the latest output value k_{i_f} acquired for each group variable xᵢ by the block 26 in which the replica temperature T_{q} is the minimum temperature Tₘᵢₙ and stored in the parallel processing memory 24 may be determined as a search result in S341.

### APPENDIX

The present specification discloses a plurality of technical ideas listed below and a plurality of combinations thereof.

### Technical Idea 1

A processing system includes a parallel processing processor in which a plurality of threads are constructed for each of a plurality of blocks, in which a combination of binary variables is optimized under a one-hot constraint, and when a group variable is defined with a combination pattern satisfying the one-hot constraint as a solution candidate for each of groups of the binary variables, the parallel processing processor is configured to execute assigning the solution candidate of the group variable for each of the threads in each of the blocks, searching for an output value of the group variable on the basis of an energy evaluation value for the solution candidate of the group variable assigned for each of the threads in each of the blocks, and outputting the output value of all the group variables having been searched.

### Technical Idea 2

In the processing system according to Technical idea 1, assigning the solution candidate includes assigning, for each of the threads, the solution candidate in which the combination pattern satisfying the one-hot constraint is expressed as an integer by a multi bit index for each of the groups of the binary variables in each of the blocks.

### Technical Idea 3

In the processing system according to Technical idea 1 or 2, assigning the solution candidate includes repeating processing of assigning the solution candidate of the same group variable for each of the threads for all the group variables in each of the blocks.

### Technical Idea 4

In the processing system according to any one of Technical ideas 1 to 3, searching for the output value includes searching for the output value by update processing based on the energy evaluation value and a transition probability for the solution candidate of the group variable assigned to each of the threads in each of the blocks.

### Technical Idea 5

In the processing system according to Technical idea 4, searching for the output value includes updating the output value from the solution candidate for each of the threads in which a difference in the energy evaluation value from before the update processing and the transition probability corresponding to the difference are acquired in accordance with simulated annealing in each of the blocks.

### Technical Idea 6

In the processing system according to Technical idea 4, searching for the output value includes updating the output value from the solution candidate for each of the threads in which the difference in the energy evaluation value from before the update processing and the transition probability corresponding to the difference are acquired in each of the blocks set as a replica of different temperatures, and exchanging the output values for which an exchange condition based on the energy evaluation value is satisfied between the blocks of adjacent temperatures in accordance with a replica exchange method.

### Technical Idea 7

In the processing system according to Technical idea 5 or 6, searching for the output value includes acquiring the solution candidate in which the difference in the energy evaluation value is the largest in a negative direction as an update value for searching for the output value in each of the blocks.

### Technical Idea 8

In the processing system according to Technical idea 7, searching for the output value includes comparing, in each of the blocks, an integrated probability obtained by integrating the transition probability with a uniformly distributed random number probability for a limited number of the solution candidates from a high probability side of the transition probability among the solution candidates in which the difference in the energy evaluation value is positive, and continuing to search for the output value by using, as the update value, the solution candidate of the transition probability adopted as the uniformly distributed random number probability among the limited number of the solution candidates in a case where the integrated probability exceeds the uniformly distributed random number probability.

### Technical Idea 9

The processing system according to any one of Technical ideas 1 or 8 further includes a host processing processor together with the parallel processing processor, in which the host processing processor is configured to execute inputting, to the parallel processing processor, the group variable in which the combination pattern satisfying the one-hot constraint for each of the groups of the binary variables is the solution candidate, and outputting a solution in which the combination pattern of the binary variables is optimized to satisfy the one-hot constraint for each of the groups by mapping the output values of all the group variables output from the parallel processing processor.

Note that the above technical idea 1 to 9 may be implemented in a form of a method and a program.

What is claimed is:

1. A processing system comprising
a parallel processing processor in which a plurality of threads is constructed for each of a plurality of blocks, and that is configured to optimize a combination of binary variables under a one-hot constraint,
wherein
when a group variable is defined with a combination pattern satisfying the one-hot constraint as a solution candidate for each of groups of the binary variables,
the parallel processing processor is configured to execute
assigning the solution candidate of the group variable for each of the threads in each of the blocks,
searching for an output value of the group variable on a basis of an energy evaluation value for the solution candidate of the group variable assigned for each of the threads in each of the blocks, and
outputting the output value of all the group variables having been searched.

2. The processing system according to claim 1, wherein
assigning the solution candidate includes assigning, for each of the threads, the solution candidate in which the combination pattern satisfying the one-hot constraint is expressed as an integer by a multi bit index for each of the groups of the binary variables in each of the blocks.

3. The processing system according to claim 1, wherein
assigning the solution candidate includes repeating processing of assigning the solution candidate of an identical group variable for each of the threads for all the group variables in each of the blocks.

4. The processing system according to claim 1, wherein
searching for the output value includes searching for the output value by update processing based on the energy evaluation value and a transition probability for the solution candidate of the group variable assigned to each of the threads in each of the blocks.

5. The processing system according to claim 4, wherein
searching for the output value includes updating the output value from the solution candidate for each of the threads in which a difference in the energy evaluation value from before the update processing and the transition probability corresponding to the difference are acquired in accordance with simulated annealing in each of the blocks.

6. The processing system according to claim 4, wherein
searching for the output value includes
updating the output value from the solution candidate for each of the threads in which the difference in the energy evaluation value from before the update processing and the transition probability corresponding to the difference are acquired in each of the blocks set as a replica of different temperatures, and
exchanging the output values for which an exchange condition based on the energy evaluation value is satisfied between the blocks of adjacent temperatures in accordance with a replica exchange method.

7. The processing system according to claim 5, wherein
searching for the output value includes acquiring the solution candidate in which the difference in the energy evaluation value is the largest in a negative direction as an update value for searching for the output value in each of the blocks.

8. The processing system according to claim 7, wherein
searching for the output value includes comparing, in each of the blocks, an integrated probability obtained by integrating the transition probability with a uniformly distributed random number probability for a limited number of the solution candidates from a high probability side of the transition probability among the solution candidates in which the difference in the energy evaluation value is positive, and continuing to search for the output value by using, as the update value, the solution candidate of the transition probability adopted as the uniformly distributed random number probability among the limited number of the solution candidates in a case where the integrated probability exceeds the uniformly distributed random number probability.

9. The processing system according to claim 1, further comprising
a host processing processor,
wherein
the host processing processor is configured to execute
inputting, to the parallel processing processor, the group variable in which the combination pattern satisfying the one-hot constraint for each of the groups of the binary variables is the solution candidate, and
outputting a solution in which the combination pattern of the binary variables is optimized to satisfy the one-hot constraint for each of the groups by mapping the output values of all the group variables output from the parallel processing processor.

10. A processing method of optimizing a combination of binary variables under a one-hot constraint by a parallel processing processor in which a plurality of threads is constructed for each of a plurality of blocks, the processing method comprising:
when a group variable is defined with a combination pattern satisfying the one-hot constraint as a solution candidate for each of groups of the binary variables,
assigning the solution candidate of the group variable for each of the threads in each of the blocks;
searching for an output value of the group variable on the basis of an energy evaluation value for the solution candidate of the group variable assigned for each of the threads in each of the blocks; and
outputting the output value of all the group variables having been searched.

11. A non-transitory computer readable storage medium storing a processing program comprising a command that is stored in the storage medium to optimize a combination of binary variables under a one-hot constraint and is executed by a parallel processing processor in which a plurality of threads is constructed for each of a plurality of blocks,
wherein
when a group variable is defined with a combination pattern satisfying the one-hot constraint as a solution candidate for each of groups of the binary variables,
the command includes
assigning the solution candidate of the group variable for each of the threads in each of the blocks,
searching for an output value of the group variable on the basis of an energy evaluation value for the solution candidate of the group variable assigned for each of the threads in each of the blocks, and
outputting the output value of all the group variables having been searched.
